(19) United States
(12) Patent Application Publication
(10) Pub. No.: US 2002/0172475 A1
(43) Pub. Date: Nov. 21, 2002

(54) Ferrule holder and method of making semiconductor laser module

(75) Inventors: Koichi Miyazaki, Tokyo (JP); Kiyokazu Tateno, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Tokyo (JP)

(21) Appl. No.: 10/077,998

(22) Filed: Feb. 20, 2002

(30) Foreign Application Priority Data
Feb. 20, 2001 (JP) 2001-044348
Apr. 12, 2001 (JP) 2001-114594

(51) Int. Cl. G02B 6/42; G02B 6/36

(52) U.S. Cl. 385/90; 385/91; 385/78

(57) ABSTRACT

The present invention provides a ferrule holder comprising an integral assembly which comprises first pinching portions for pinching the side of a ferrule in a optical ferrule-attached fiber through a line contact of about 2 mm in the longitudinal direction of the ferrule and second pinching members for pinching the side of the ferrule through a line contact of about 0.5 mm in the longitudinal direction of the ferrule, when the adjustment of optical axis in the optical ferrule-attached fiber is to be performed before it is optically coupled with an optical part. Since the adjustment of optical axis is performed while pinching the side of the ferrule through the relatively short line contact in the longitudinal direction of the ferrule after the ferrule has been fixed to a first supporting member, the sufficient range of leverage movement can be secured. At the same time, the YAG welding portions between the first supporting member and the ferrule can be prevented from being damaged or deformed due to an excess load thereon.

### BACKGROUND OF THE INVENTION

The present invention relates to a ferrule holder for holding a ferrule of an optical ferrule-attached fiber to be optically coupled with an optical part such as a semiconductor laser element when the optical fiber is being adjusted relating to its optical axis, and a method of making a semiconductor laser module.

In general, the alignment of optical axis in a optical ferrule-attached fiber when it is optically coupled with an optical part such as a light-emitting element, light-receiving element, lens or prism is carried out by moving the optical ferrule-attached fiber. For example, when an semiconductor laser module including an semiconductor laser element used as a light-emitting element, with the laser beam therefrom being condensed by a lens and then received by an optical ferrule-attached fiber, is to be welded to the optical ferrule-attached fiber through YAG laser, it is required to align the optical axis with a plane perpendicular to the optical axis (or, strictly, a plane parallel to the end face of the semiconductor laser module: X-Y plane) and with a direction of optical axis (or a direction perpendicular to the X-Y plane: Z direction).

To provide an increased efficiency of optical coupling, there is also known a semiconductor laser module of such a type that the laser beam from a semiconductor laser element is not condensed by a lens, but is optically coupled directly with a optical ferrule-attached fiber having its tensed tip.

### SUMMARY OF THE INVENTION

The present invention provides a ferrule holder for holding a ferrule of an optical ferrule-attached fiber to be optically coupled with an optical part, said ferrule holder comprising a pair of pinching members for pinching said ferrule at the side thereof through a line contact being relatively short in the longitudinal direction of the ferrule or a point contact.

The present invention also provides a ferrule holder comprising a pair of pinching members for pinching a ferrule of an optical ferrule-attached fiber to perform the adjustment of optical axis in the optical ferrule-attached fiber when it is to be optically coupled with an optical part, each of said pair of pinching members being formed with a pinching groove extending along the axis of said ferrule.

The present invention further provides a method of making a semiconductor laser module comprising a semiconductor laser element and an optical ferrule-attached fiber for receiving the laser beam from the semiconductor laser element, comprising the step of performing the adjustment of optical axis in the optical ferrule-attached fiber while pinching the ferrule at the side thereof through a line contact relatively short in the longitudinal direction of the ferrule or a point contact.

The present invention further provides a method of making a semiconductor laser module comprising a semiconductor laser element and an optical ferrule-attached fiber for receiving the laser beam from the semiconductor laser element, comprising a first step of performing the adjustment of optical axis in the optical ferrule-attached fiber while pinching said ferrule at at least two side locations through a line contact relatively long or short in the longitudinal direction of the ferrule or a point contact and a second step of performing the adjustment of optical axis in the optical ferrule-attached fiber while pinching said ferrule at the side through a line contact relatively short in the longitudinal direction of the ferrule or a point contact.

The present invention further provides a method of making a semiconductor laser module, comprising the step of performing the adjustment of optical axis in the optical ferrule-attached fiber while pinching said ferrule by a ferrule holder through the pinching grooves formed in a pair of pinching members thereof.

The present invention further provides a method of making a semiconductor laser module, comprising the steps of fixedly mounting a semiconductor laser element on a base; fixedly mounting a cooling device in a package; fixedly mounting said base on said cooling device; introducing an optical ferrule-attached fiber into the package through a through-aperture formed through the side of said package; fixedly mounting said optical ferrule-attached fiber on said base after the adjustment of optical axis has been carried out through the aforementioned method; fixedly mounting said optical ferrule-attached fiber in the through-aperture of said package; and air-tightly sealing said package by a closure.

### BRIEF DESCRIPTION OF THE DRAWINGS

FIG. 1 shows a ferrule holder constructed according to the first embodiment of the present invention: FIG. 1(A) is a side view thereof; and FIG. 1(B) is atop view thereof.

FIG. 2 shows a pair of pinching members used in the ferrule holder according to the first embodiment of the present invention: FIG. 2(A) is a perspective view thereof; FIG. 2(B) is a front view thereof, illustrating the pinching members before they pinch the ferrule; FIG. 2(C) is a view similar to FIG. 2(B), illustrating the pinching members while pinching the ferrule; and FIG. 2(D) is a top view illustrating a pair of modified pinching members.

FIGS. 3(A) to (D) illustrate a process of performing the adjustment of optical axis in an optical ferrule-attached fiber using the ferrule holder according to the first embodiment of the present invention.

FIGS. 4(A) and (B) are front cross-sectional views illustrating the contact between the side of the ferrule and the inner wall of the main body.

FIG. 5 shows a pair of pinching members according to the second embodiment of the present invention: FIGS. 5(A) and (B) are front cross-sectional views illustrating the pinching members which pinch the ferrule at the side thereof; and FIGS. 5(C) and (D) are front cross-sectional views illustrating a pair of further modified pinching members.

FIG. 6 shows a ferrule holder constructed according to the third embodiment of the present invention: FIG. 6(A) is a perspective view of the first pinching members; FIG. 6(B) is a front view of the second pinching members; FIG. 6(C) is a front view illustrating the second pinching members which pinch the ferrule; and FIG. 6(D) is a top view illustrating the second pinching members which pinch the ferrule.

FIG. 7 shows a pair of pinching members used in a ferrule holder according to the fourth embodiment of the present invention: FIG. 7(A) is a perspective view thereof; and FIG. 7(B) is a front view thereof, illustrating the ferrule pinched by these pinching members.

FIGS. 8(A) to (D) illustrate a process of making a semiconductor laser module according to the fourth embodiment of the present invention.

FIG. 9 is a perspective view of a pair of pinching members used in a ferrule holder according to the fifth embodiment of the present invention.

FIG. 10 shows a pair of pinching members used in a ferrule holder according to the sixth embodiment of the present invention: FIG. 10(A) is a perspective view thereof; FIG.10(B) is a front view thereof; FIG. 10(C) is a front view illustrating the pair of pinching members which are closed to pinch the ferrule at the side thereof in a non-swingable manner; FIG. 10(D) is a front view illustrating the pair of pinching members which are opened into a predetermined spacing to pinch the ferrule at the side thereof in a swingable manner.

FIGS. 11(A) to (D) illustrate a process of performing the adjustment of optical axis in an optical ferrule-attached fiber 3 having a ferrule 2 through the ferrule holder 29 according to the first embodiment of the present invention.

FIG. 12 is a front view of a ferrule holder according to the seventh embodiment of the present invention: FIG. 12(A) illustrates a pair of pinching members which are closed to pinch the ferrule at the side thereof in a non-swingable manner; and FIG. 12(B) illustrates the pair of pinching members which are opened into a predetermined spacing to pinch the ferrule at the side thereof in a swingable manner.

FIGS. 13(A) to (D) are front views showing various modifications of pinching members.

FIG. 14 illustrates a process of making a semiconductor laser module according to the eighth embodiment of the present invention.

FIG. 15 shows a pair of pinching members used in a ferrule holder according to the prior art: FIG. 15(A) is a perspective view thereof; and FIG. 15(B) is a front view thereof, illustrating the pair of pinching members which pinch the ferrule.

FIG. 16 illustrates the problem raised in the prior art.

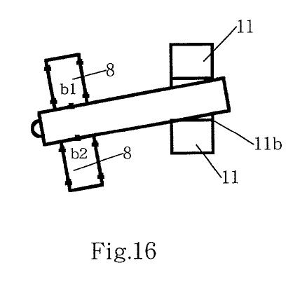

### DETAILED DESCRIPTION

In comparison with the prior art, several preferred embodiments of the present invention will now be described with reference to the drawings.

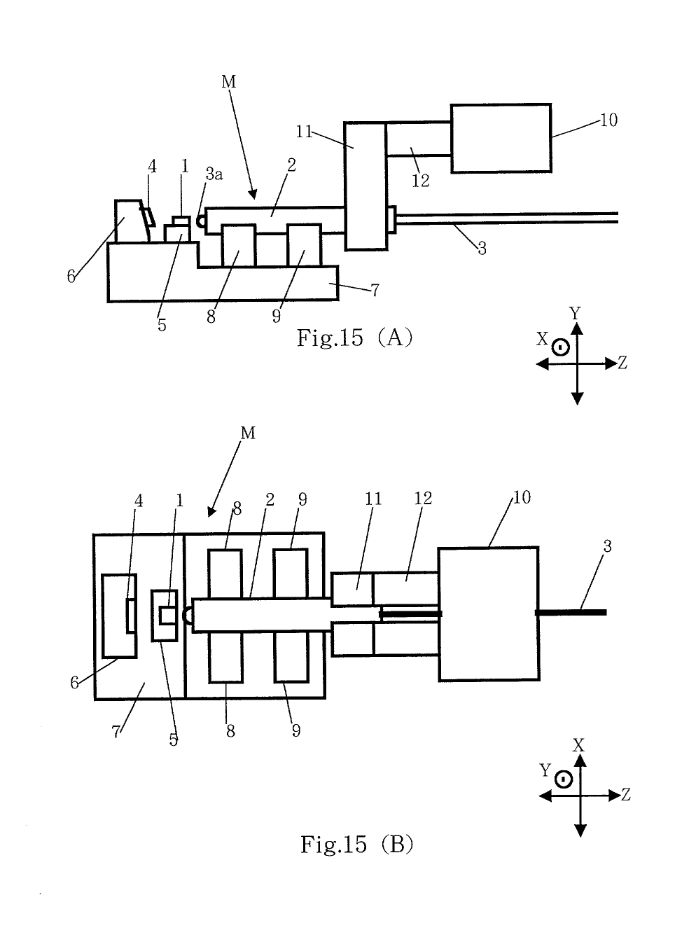

FIG. 15 diagrammatically shows a semiconductor laser module constructed according to the prior art and comprising an optical ferrule-attached fiber which has one lensed end. As shown in FIG. 15, the semiconductor laser module M comprises a semiconductor laser element 1 adapted to emit a laser beam; an optical fiber 3 having a ferrule 2, the optical fiber 3 being adapted to receive the laser beam from the front facet of the semiconductor laser element 1 (or the right facet as viewed in FIG. 15); a photodiode 4 adapted to receive the laser beam from the rear facet of the semiconductor laser element (or the left facet as viewed in FIG. 15); an LD carrier 5 on which the semiconductor laser element 1 is mounted; a PD carrier 6 on which the photodiode 4 is mounted; and a base 7 on which the LD carrier 6, PD carrier 6 and the optical ferrule-attached fiber 3 are mounted.

The end of the optical fiber 3 opposite to the semiconductor laser element 1 is formed with a lens portion 3a of wedge-shaped or other configuration.

The ferrule 2 is fixedly mounted, at the side thereof, on first and second supporting members 8, 9 through YAG laser welding. The first and second supporting members 8, 9 are fixedly mounted on the base 7 through YAG laser welding.

The laser beam emitted from the front facet of the semiconductor laser element 1 is received by the lens portion 3a of the optical ferrule-attached fiber 3 and externally fed through the optical fiber 3.

The monitoring laser beam emitted from the rear facet of the semiconductor laser element 1 is received by the photodiode 4. The optical output and other functions in the semiconductor laser element 1 are regulated depending on the amount of light at the photodiode 4.

In the prior art process of making the semiconductor laser module M, the adjustment of optical axis in the optical ferrule-attached fiber 3 was carried out using a ferrule holder 10 for holding the ferrule 2.

The ferrule holder 10 comprises a pair of pinching members 11 for pinching the ferrule 2 at the side thereof and an opening/closing member 12 for opening/closing the pinching members 11. The opening/closing member 12 may be actuated to open or close the pinching members 11 through a pneumatic cylinder having an extendable rod.

The adjustment of optical axis using the ferrule holder 10 of the prior art is carried out as follows.

(1) The first supporting member 8 is first positioned on the ferrule 2. The alignment of optical axis relative to the X-, Y- and Z-axis directions in the ferrule 2 is then carried out while maintaining the clearance between the ferrule 2 and the first supporting member 8. Thereafter, the first supporting member 8 is fixed to the base 7 through YAG laser welding.

(2) The ferrule 2 is then moved in the X-, Y- and Z-axis directions to perform the alignment of optical axis between the semiconductor laser element 1 and the optical fiber 3. Thereafter, the side of the ferrule 2 is fixed to the first supporting member 8 through YAG laser welding.

(3) The second supporting member 9 is then positioned on the ferrule 2. The alignment of optical axis relative to the X- and Y-axis directions in the ferrule 2 is then carried out. Thereafter, the second supporting member 9 is fixed to the base 7 through YAG laser welding.

(4) The ferrule 2 is then moved in the Y-axis direction or the X-and Y-axis directions about the YAG laser welding portion between the first supporting member 8 and the ferrule 2 in a leverage manner. The alignment of optical axis between the semiconductor laser element 1 and the optical fiber 3 is then carried out. Thereafter, the side of the ferrule 2 is fixed to the second supporting member 9 through YAG laser welding. In such a process, the alignments of optical axis relative to the X- and Y-axis directions in the steps (3) and (4) are carried out using the leverage of the ferrule 2 about the YAG laser welding portion between the first supporting member 8 and the side of the ferrule 2. If the ferrule 2 is moved up and down or left and right, the edges of a pinching groove 11b formed between the pinching members 11 may interfere with the side of the moved ferrule 2. Thus, the movement of the ferrule 2 will be restricted. If the ferrule 2 is further moved in such a situation, the YAG laser welding spots b1 and b2 between the first supporting member 8 and the ferrule 2 will be subjected to an excess load. This may crack the YAG laser welding spots, thereby reducing the reliability in the semiconductor laser module.

To overcome the aforementioned problem, an object of the embodiment of the present invention is to provide a ferrule holder which can avoid any excess load on the supporting members and ferrule and which can perform the adjustment of optical axis while holding the ferrule at a proper position and with an appropriate pinching force, and to provide a method of making a semiconductor laser module using such a ferrule holder.

Another object of the embodiment of the present invention is to provide a ferrule holder which can avoid any excess load on the supporting members and ferrule and which can shorten time required to perform the alignment of optical axis, and to provide a method of making a semiconductor laser module using such a ferrule holder.

### FIRST EMBODIMENT

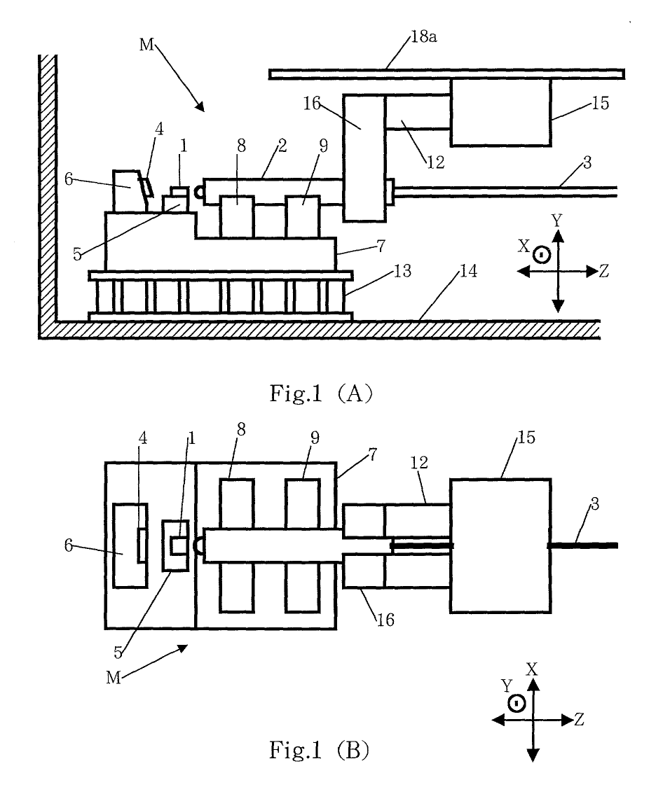

FIG. I shows a ferrule holder constructed according to the first embodiment of the present invention: FIG. 1(A) is a side view thereof; and FIG. 1(B) is a top view thereof. In this figure, parts similar those of the illustrated prior art are denoted by similar reference numerals and will not further described.

Referring to FIG. 1, a semiconductor laser module M comprises a semiconductor laser element 1, an optical ferrule-attached fiber 3 having a ferrule 2, a photodiode 4, an LD carrier 5, a PD carrier 6 and a base 7. The base 7 is mounted on a cooling device 13 for cooling the semiconductor laser element 1.

According to this embodiment of the present invention, a method of making a semiconductor laser module uses a ferrule holder 15 for holding the ferrule 2 in a step of performing the adjustment of optical axis in the optical ferrule-attached fiber 3.

The ferrule holder 15 comprises a pair of pinching members 16 and an opening/closing member 12 for opening/closing the pinching members 16 through a pneumatic cylinder. The ferrule holder 15 is movable on an overhead rail means 18a in the Z-axis direction.

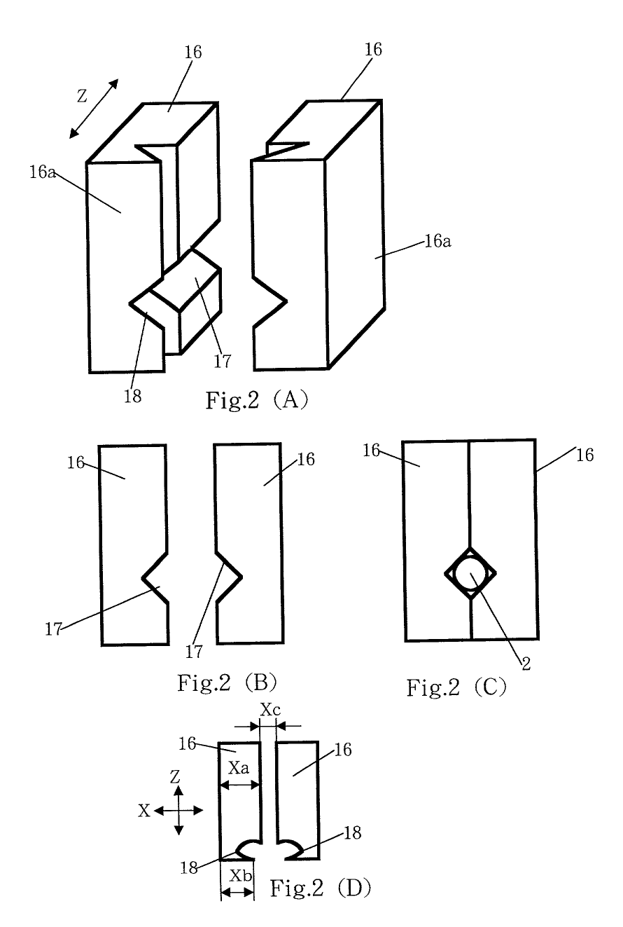

FIG. 2 shows a pair of pinching members 16 used in the ferrule holder 15 according to the first embodiment of the present invention: FIG. 2(A) is a perspective view thereof; FIG. 2(B) is a front view thereof, illustrating the pinching members before they pinch the ferrule2; and FIG. 2(C) is a view similar to FIG. 2(B), illustrating the pinching members while pinching the ferrule.

Referring to FIG. 2, each of the pinching members 16 used in the ferrule holder 15 according to the first embodiment of the present invention has a main body 16a formed of such a material as Fe, Al, stainless steel or any other alloy. The main body 16a comprises a first pinching portion 17 for pinching the ferrule 2 at the side thereof through a line contact relatively short in the longitudinal direction (e.g., about 2 mm) and a second pinching portion 18 for pinching the ferrule 2 at the side thereof through a line contact relatively short in the longitudinal direction (e.g., about 0.5 mm,) or a point contact. The relatively short line contact is preferably longer than 0.001 mm and less than 1 mm. If this line contact is less than 0.001 mm, it is difficult to produce such a ferrule holder 15.

The first and second pinching portions 17, 18 are of V-shaped groove that is formed on the inner wall of the main body 16a and extends in the longitudinal direction Z of the module. However, the first pinching portion or V-shaped groove 17 has a width extending in the longitudinal direction Z in any event while the second pinching portion or V-shaped groove 18 has a sharp edge having almost no width in the longitudinal direction Z.

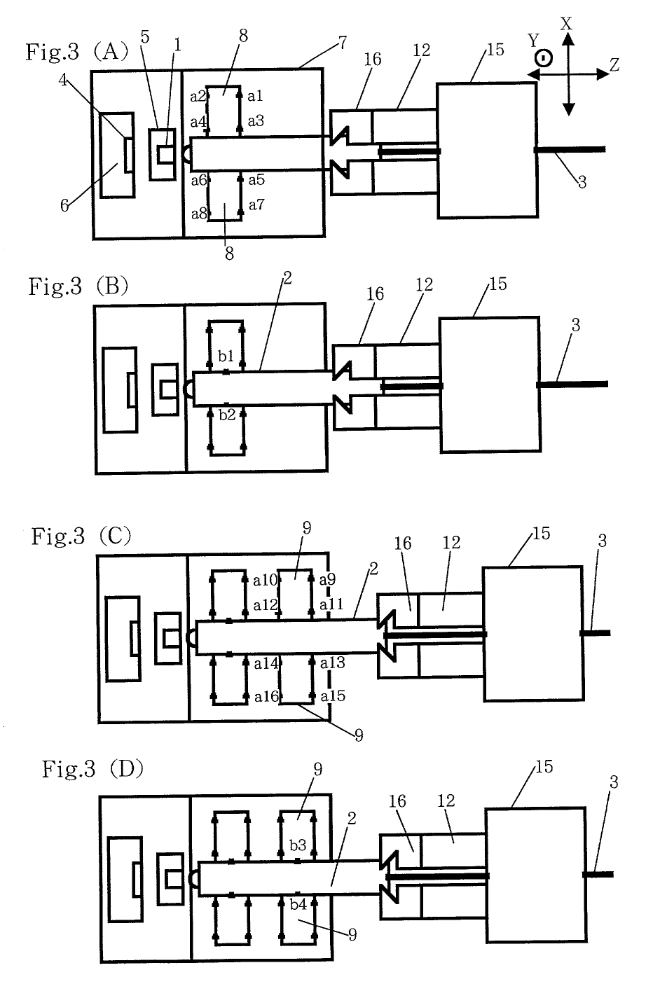

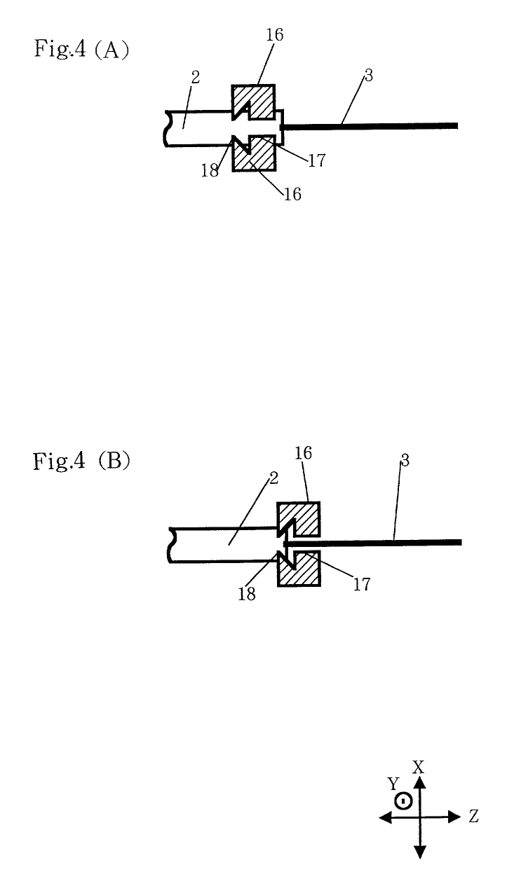

FIGS. 3(A) to (D) illustrate a process of performing the adjustment of optical axis in the optical ferrule-attached fiber 3 using the ferrule holder 15 according to the first embodiment of the present invention. FIGS. 4(A) and (B) are plan cross-sectional views illustrating the contact between the side of the ferrule 2 and the inner wall of the main body 16a.

First of all, the LD carrier 5 on which the semiconductor laser element 1 has been mounted as well as the PD carrier 6 on which the photodiode 4 has been mounted are soldered on the base 7.

The ferrule 2 is then pinched, at the side thereof, by the first pinching portions 17 of the pinching member pair 16 in the ferrule holder 15 (see FIG. 4(A)). A first supporting member 8 is positioned for the ferrule 2. If necessary, the gap between the ferrule 2 and the first supporting member 8 may be adjusted and determined. Thereafter, the alignment of optical axis in the ferrule 2 is carried out in the X-, Y- and Z-axis directions. Thereafter, the first supporting member 8 is fixed to the base 7 through YAG laser welding (see FIG. 3(A) relating to welding spots a1-a8).

Subsequently, the alignment of optical axis in the ferrule 2 is again carried out in the X-, Y- and Z-axis directions under the same condition. Thereafter, the front side of the ferrule 2 (or the side thereof facing the semiconductor laser element 1) is fixed to the first supporting member 8 through YAG laser welding (see FIG. 3(B) relating to welding spots b1 and b2).

The pinching members 16 are opened by the opening/closing member 12 so that the ferrule 2 will not be moved. The ferrule holder 15 is then moved rearward (or rightward as viewed in FIG. 3) along the Z-axis. Thereafter, the pinching members 16 are closed to pinch the side of the ferrule 2 only through the second pinching portions 18 (see FIG. 4(B)).

Under such a situation, a second supporting member 9 is positioned for the ferrule 2. The ferrule 2 is moved about the welding spots b1, 2b between the first supporting member 8 and the ferrule2 in a leverage manner to perform the alignment of optical axis in the ferrule 2 in the X- and Y-axis directions. Thereafter, the second supporting member 9 is fixed to the base 7 through YAG laser welding (see FIG. 3(C) relating to welding spots a9-a16).

Finally, the ferrule 2 is moved in the Y-axis direction or in the X- and Y-axis directions while holding the ferrule 2 at the side thereof through the second pinching portions 18. The ferrule 2 is then moved about the welding spots b1, b2 between the first supporting member 8 and the ferrule 2 in a leverage manner so that the alignment of optical axis between the semiconductor laser element 1 and the optical fiber 3 will be performed. Thereafter, the side of the ferrule 2 is fixed to the second supporting member 9 through YAG laser welding (see FIG. 3(D) relating to the welding spots b3 and b4).

According to the first embodiment of the present invention, the adjustment of optical axis is carried out while pinching the side of the ferrule 2 through a relatively short line contact or a point contact along the longitudinal direction of the ferrule 2 after the ferrule 2 has been fixed to the first supporting member 8. Therefore, the range of leverage movement can sufficiently be secured while at the same time any of the welding spots b1, b2 or a1-a8 can be prevented from being cracked, damaged or deformed. As a result, the reliability in the product can be improved.

The second pinching portions 18 may be of U-shaped configuration as viewed in the plane, as shown in FIG. 2(D). The main body of each of the pinching portions 16 may have a width Xa smaller than a width Xb in the forward end of the pinching member 16. The width Xb may further be reduced if the gap Xc between the pinching portions 16 remains equal to or larger than 0 when the ferrule 2 is pinched by the second pinching portions 18.

### SECOND EMBODIMENT

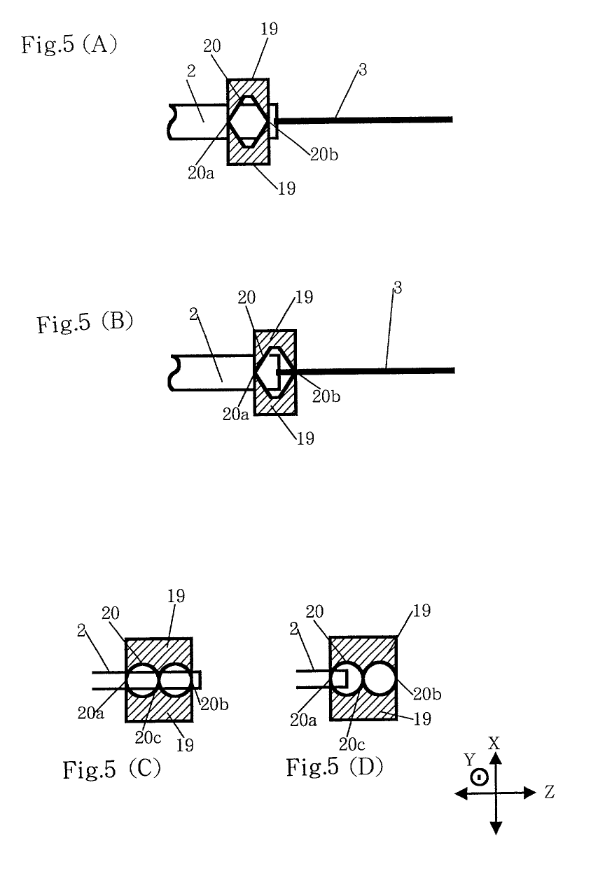

FIG. 5 shows a pair of pinching members according to the second embodiment of the present invention: FIGS. 5(A) and (B) are front cross-sectional views illustrating the pinching members which pinch the ferrule at the side thereof; and FIGS. 5(C) and (D) are front cross-sectional views illustrating a pair of further modified pinching members.

Referring FIG. 5, each of a pair of pinching members 19 according to the second embodiment of the present invention includes a main body 19a formed of any suitable material such as Fe, Al, stainless steel or other alloy. The main body 19a includes a pinching groove 20 formed therein along the longitudinal direction Z and in symmetry to the axis of the ferrule 2. The pinching groove 20 is concave in the X-axis direction as shown in FIGS. 5(A) and (B) and has first and second edges 20a, 20b at the proximal and distal ends thereof, these edges being adapted to pinch the side of the ferrule 2 through a relatively short line contact.

According to the second embodiment, the side of the ferrule 2 at the forward end (which faces the semiconductor laser element 1) is fixed to a first supporting member 8 through YAG laser welding while pinching the side of the ferrule 2 at two points between the first and second edges 20a, 20b of the pinching grooves 20 in the pinching members 19 (see FIG. 5(A)). Thereafter, the pinching members 19 are opened by the opening/closing member 12 so that the ferrule 2 will not be moved. The ferrule holder 15 is then moved rearward along the Z-axis direction. Thereafter, the pinching members 19 are closed to pinch the side of the ferrule 2 at the first edges 20a (see FIG. 5(B)).

The side of the ferrule 2 may be pinched at three or more points through the relatively short line contact in the longitudinal direction of the ferrule 2 or the point contact. For example, as shown in FIGS. 5(C) and (D), each of the pinching members 19 may include two concave pinching grooves 20 extending parallel to each other in the X-axis direction. In this case, the two adjacent pinching grooves provide three edges 20a, 20b and 20c for pinching the side of the ferrule 2 through a relatively short line contact.

According to such modified pinching members 19, the forward end of the ferrule 2 (which faces the semiconductor laser element 1) is fixed to the first supporting member 8 through YAG laser welding while holding the side of the ferrule 2 at three points by the three edges 20a, 20b and 20c in the pinching grooves 20 (see FIG. 5(C)). Thereafter, the pinching members 19 are opened by the opening/closing member 12 so that the ferrule 2 will not be moved. The ferrule holder 15 is then moved rearward along the Z-axis direction. Thereafter, the pinching members 19 are closed to pinch the side of the ferrule 2 at the first edges 20a (see FIG. 5(D)).

### THIRD EMBODIMENT

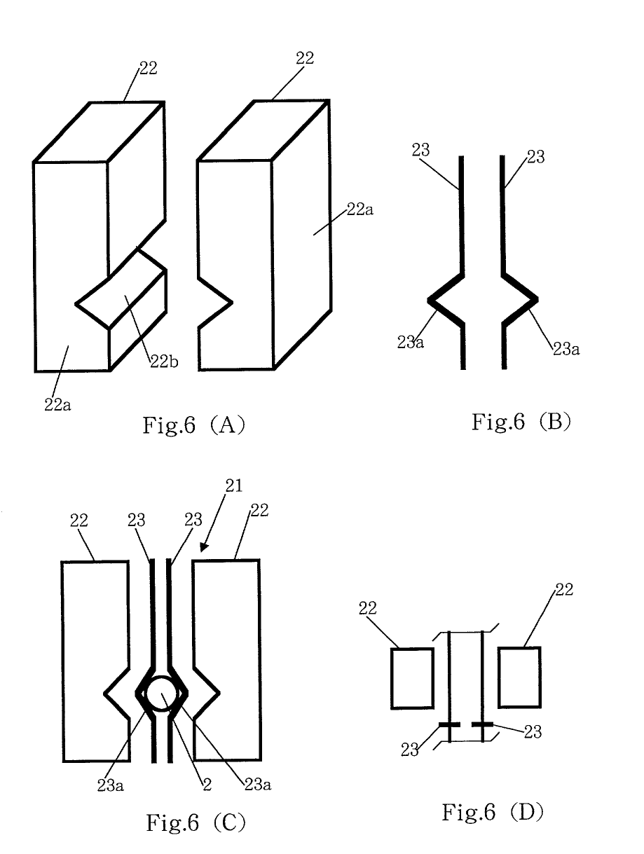

FIG. 6 shows a ferrule holder constructed according to the third embodiment of the present invention: FIG. 6(A) is a perspective view of first pinching members 22; FIG. 6(B) is a front view of second pinching members 23; FIG. 6(C) is a front view illustrating the second pinching members which pinch the ferrule 2; and FIG. 6(D) is a top view illustrating the second pinching members 23 which pinch the ferrule 2.

Referring to FIG. 6, a ferrule holder 21 according to the third embodiment comprises a pair of first pinching members 22 for pinching the side of the ferrule 2 through a relatively long line contact (e.g., 1.5 mm) in the longitudinal direction of the ferrule 2 and a pair of second pinching members 23 for pinching the side of the ferrule 2 through a relatively short line contact (e.g., 0.8 mm) in the longitudinal direction of the ferrule 2 or a point contact.

Each of the first pinching portions 22 includes a main body 22a formed of any suitable material such as Fe, Al, stainless steel or other alloy. The main body 22a includes a V-shaped pinching groove formed therein at the inner wall. The side of the ferrule 2 will be pinched by and between the pinching grooves 22b in the pinching member pair 22.

Each of the second pinching members 23 is in the form of a rod. The rod includes a V-shaped bent portion 23a at a predetermined location. The side of the ferrule 2 will be pinched by and between the bent portions 23a of the second pinching member pair 23.

The first and second pinching members 22, 23 may be opened or closed independently through the opening/closing member 12.

A process of performing the adjustment of optical axis in the optical ferrule-attached fiber 3 using the ferrule holder 21 according to the third embodiment of the present invention will be described.

First of all, the LD carrier 5 on which the semiconductor laser element 1 has been mounted as well as the PD carrier 6 on which the photodiode 4 has been mounted are soldered to the base 7.

Subsequently, the side of the ferrule 2 is pinched by and between the pinching grooves 22b of the first pinching member pair 22 in the ferrule holder 21. At this time, the side of the ferrule 2 may be pinched by and between the bent portions 23a of the second pinching member pair 23. The first supporting member 8 is then positioned along the ferrule 2 in place. If necessary, the gap between the ferrule 2 and the first supporting member 8 is secured. After the alignment of optical axis in the ferrule 2 is then performed in the X-, Y- and Z-axis directions, the first supporting member 8 is fixed to the base 7 through YAG laser welding (welding spots a1-a8).

Subsequently, the alignment of optical axis in the ferrule 2 is again carried out in the X-, Y- and Z-axis directions under the same condition. Thereafter, the forward end of the ferrule 2 (which faces the semiconductor laser element 1) is fixed to the first supporting member 8 through YAG laser welding (welding spots b1 and b2).

Subsequently, the first pinching members 22 are opened by the opening/closing member 12. The side of the ferrule 2 is pinched by and between the bent portions 23 of the second pinching members 23.

Under such a condition, the second supporting member 9 is positioned along the ferrule 2 in place. The ferrule 2 is then moved about the YAG laser welding spots b1 and b2 between the first supporting member 8 and the ferrule 2 in a leverage manner so that the alignment of optical axis in the ferrule 2 will be carried out in the X- and Y-axis directions. Thereafter, the second supporting member 9 is fixed to the base 7 through YAG laser welding (welding spots b9-b16).

Finally, the ferrule 2 is moved in the Y-axis direction or the X- and Y-axis directions. The ferrule 2 is moved about the YAG laser welding spots b1 and b2 between the first supporting member 8 and the ferrule 2 in a leverage manner. The alignment of optical axis between the semiconductor laser element 1 and the optical fiber 3 is then carried out. Thereafter, the side of the ferrule 2 is fixed to the second supporting member 9 through YAG laser welding (welding spots b3 and b4).

According to the third embodiment of the present invention, the alignment of optical axis can more surely be carried out since two types of first and second pinching members 22, 23 are used.

After the ferrule 2 has been fixed to the first supporting member 8, it is not required that the ferrule holder 21 is moved rearward.

### FOURTH EMBODIMENT

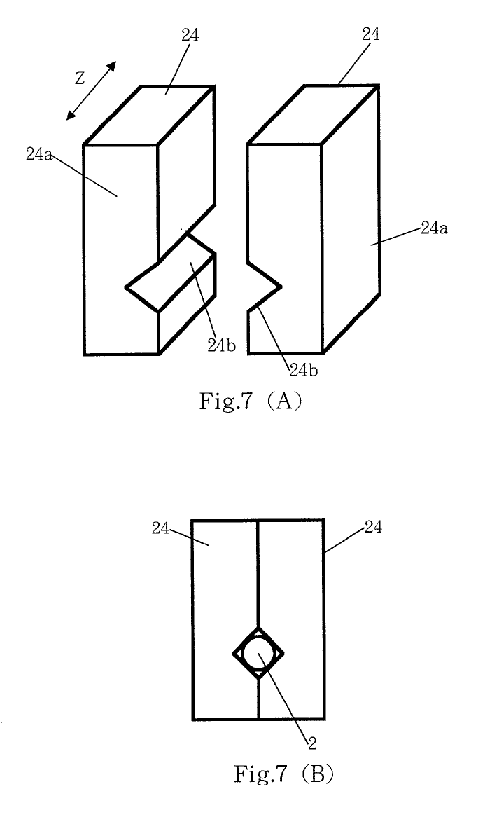

FIG. 7 shows a pair of pinching members 24 used in a ferrule holder according to the fourth embodiment of the present invention: FIG. 7(A) is a perspective view thereof; and FIG. 7(B) is a front view thereof, illustrating the ferrule pinched by these pinching members 24.

Referring to FIGS. 7(A) and (B), each of the pinching portions 24 has a main body 24a formed of any suitable material such as Fe, Al, stainless steel or other alloy. The main body 24a includes a V-shaped pinching groove 24b formed therein at the inner wall thereof and extending in the longitudinal direction.

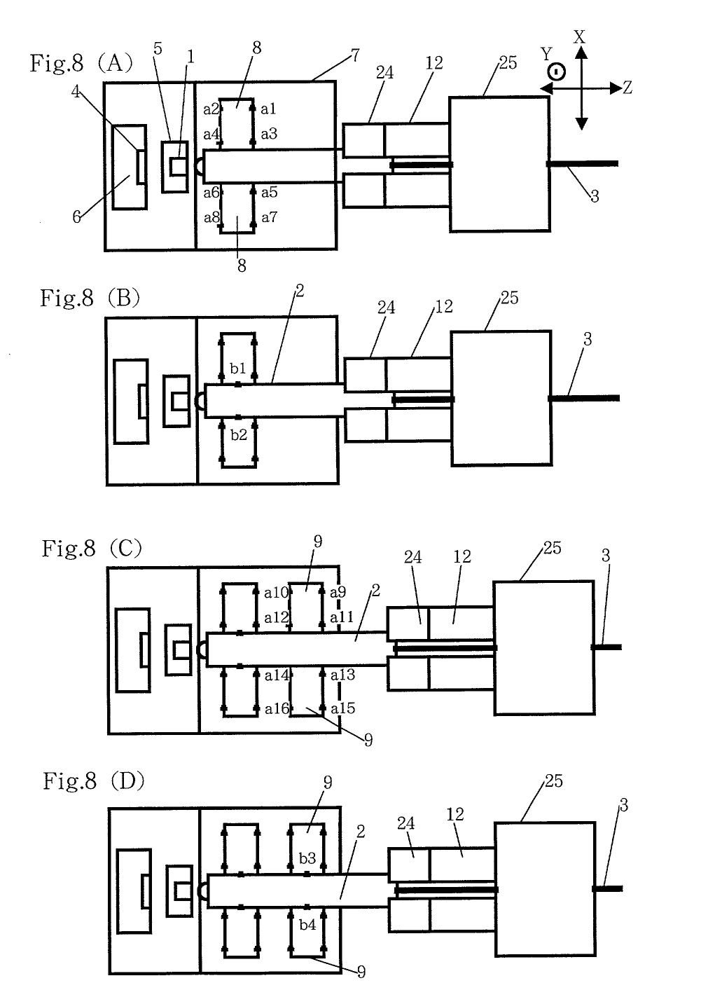

FIGS. 8(A) to (D) illustrate a process of making a semiconductor laser module according to the fourth embodiment of the present invention. The fourth embodiment is characterized by that it performs the adjustment of optical axis in the optical ferrule-attached fiber using a ferrule holder 25 which is provided with such pinching members 24 as shown in FIG. 7.

First of all, the LD carrier 5 on which the semiconductor laser element 1 has been mounted as well as the PD carrier 6 on which the photodiode 4 has been mounted are soldered to the base 7.

Subsequently, the side of the ferrule 2 is pinched by and between the pinching grooves 24b of the first pinching member pair 24 in the ferrule holder 25. The first supporting member 8 is then positioned along the ferrule 2 in place. If necessary, the gap between the ferrule 2 and the first supporting member 8 is secured. After the alignment of optical axis in the ferrule 2 is then performed in the X-, Y- and Z-axis directions, the first supporting member 8 is fixed to the base 7 through YAG laser welding (see FIG. 8(A) relating to welding spots a1-a8).

Subsequently, the alignment of optical axis in the ferrule 2 is again carried out in the X-, Y- and Z-axis directions under the same condition. Thereafter, the forward end of the ferrule 2 (which faces the semiconductor laser element 1) is fixed to the first supporting member 8 through YAG laser welding (see FIG. 8(B) relating to welding spots b1 and b2).

Subsequently, the pinching members 24 are opened by the opening/closing member 12 so that the ferrule 2 will not be moved. The ferrule holder 25 is then moved rearward (or rightward as viewed in FIG. 8) along the Z-axis direction. The pinching members 24 are then closed to pinch the side of the ferrule 2 through the pinching grooves 24b.

Under such a condition, the second supporting member 9 is positioned along the ferrule 2 in place. The alignment of optical axis in the ferrule 2 is then carried out in the X- and Y-axis directions. Thereafter, the second supporting member 9 is fixed to the base 7 through YAG laser welding (see FIG. 8(C) relating to welding spots a9-a16).

Finally, the ferrule 2 is moved in the Y-axis direction or the X- and Y-axis directions. The ferrule 2 is moved about the YAG laser welding spots b1 and b2 between the first supporting member 8 and the ferrule 2 in a leverage manner. The alignment of optical axis between the semiconductor laser element 1 and the optical fiber 3 is then carried out. Thereafter, the side of the ferrule 2 is fixed to the second supporting member 9 through YAG laser welding (see FIG. 8(D) relating to welding spots b3 and b4).

According to the fourth embodiment, the pinching grooves 24b can easily be machined in the pinching members 24. This can reduce the machining cost in the pinching members.

### FIFTH EMBODIMENT

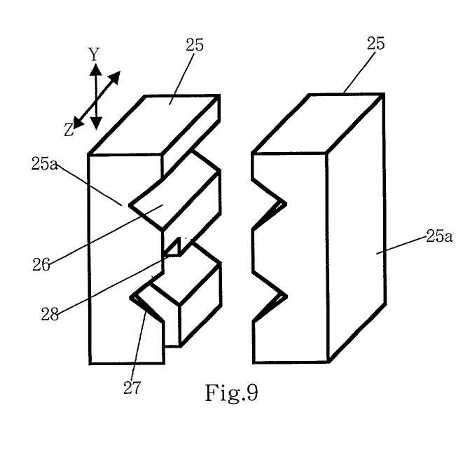

FIG. 9 is a perspective view of a pair of pinching members used in a ferrule holder according to the fifth embodiment of the present invention.

Each pinching member 25 according to the fifth embodiment has a main body 25a formed of any suitable material such as Fe, Al, stainless steel or other alloy. The main body 25a is formed with a first pinching portion 26 for pinching the side of the ferrule 2 through a line contact relatively long in the longitudinal direction of the ferrule 2 (e.g., about 4 mm) and a second pinching portion 27 for pinching the side of the ferrule 2 through a line contact relatively short in the longitudinal direction of the ferrule 2 (e.g., about 0.5 mm) or a point contact. Each of the first and second pinching portions 26, 27 is a V-shaped cross-sectional groove formed in the inner wall of the main body 25a and extending in the longitudinal direction Z of the module. However, the first pinching portion or groove 26 has flat sidewalls having a width in the longitudinal direction Z while the second pinching portion or groove 27 has a sharp edge having almost no width in the longitudinal direction Z, such a sharp edge being formed by forming a notch 28 in the inner wall of the pinching member.

The fifth embodiment is different from the first embodiment in that the first and second pinching portions 26, 27 in each of the pinching members 25 are located spaced apart from each other in the direction across the pinching member 25. Thus, when the side of the ferrule 2 is pinched by and between the first pinching portions 26, the side of the forward portion of the ferrule 2 (which faces the semiconductor laser element 1) will be fixed to the first supporting member 8 through YAG laser welding. The pinching members 25 are then opened by the opening/closing member 12 so that the ferrule 2 will not be moved. The ferrule holder 15 is then moved upward along the Y-axis direction. The pinching members 24 are then closed to pinch the side of the ferrule 2 by the second pinching portions 27.

### SIXTH EMBODIMENT

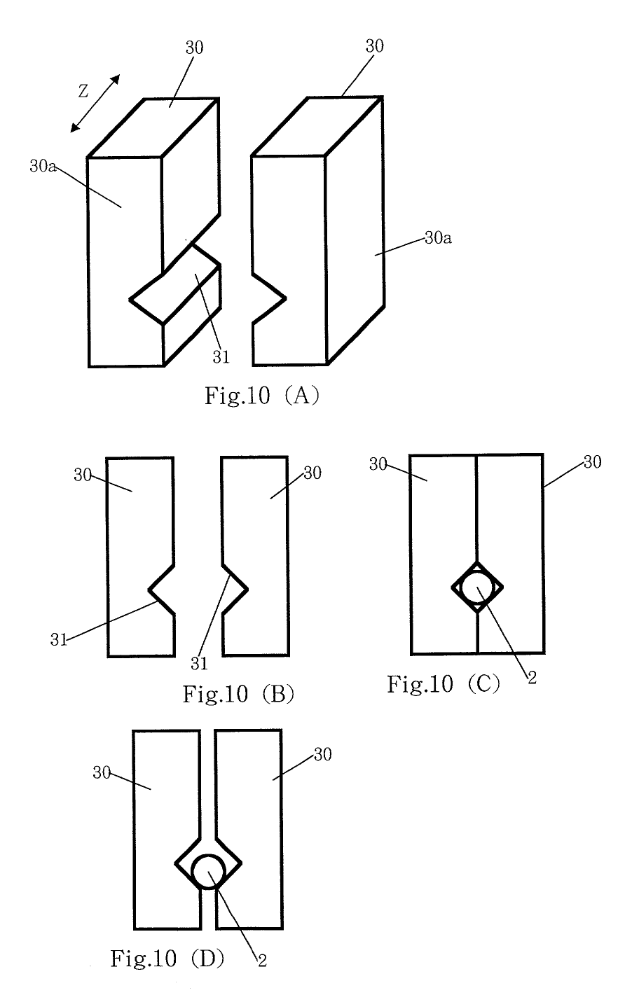

FIG. 10 shows a pair of pinching members 30 used in a ferrule holder 29 according to the sixth embodiment of the present invention: FIG. 10(A) is a perspective view thereof; FIG. 10(B) is a front view thereof; FIG. 10(C) is a front view illustrating the pair of pinching members 30 which are closed to pinch the side of the ferrule 2 in a non-swingable manner; FIG. 10(D) is a front view illustrating the pair of pinching members 30 which are opened into a predetermined spacing to pinch the side of the ferrule 2 in a swingable manner.

Referring to FIG. 10, the pinching portions 30 is used in the ferrule holder 15 according to the first embodiment of the present invention. Each of the pinching members 30 has a main body 30a formed of any suitable material such as Fe, Al, stainless steel or other alloy. The main body 30a includes a V-shaped pinching groove 31 formed on the inner wall thereof and extending in the longitudinal direction Z. The pinching grooves 31 in the two pinching members 30 are symmetrical to each other about the axis of the ferrule 2.

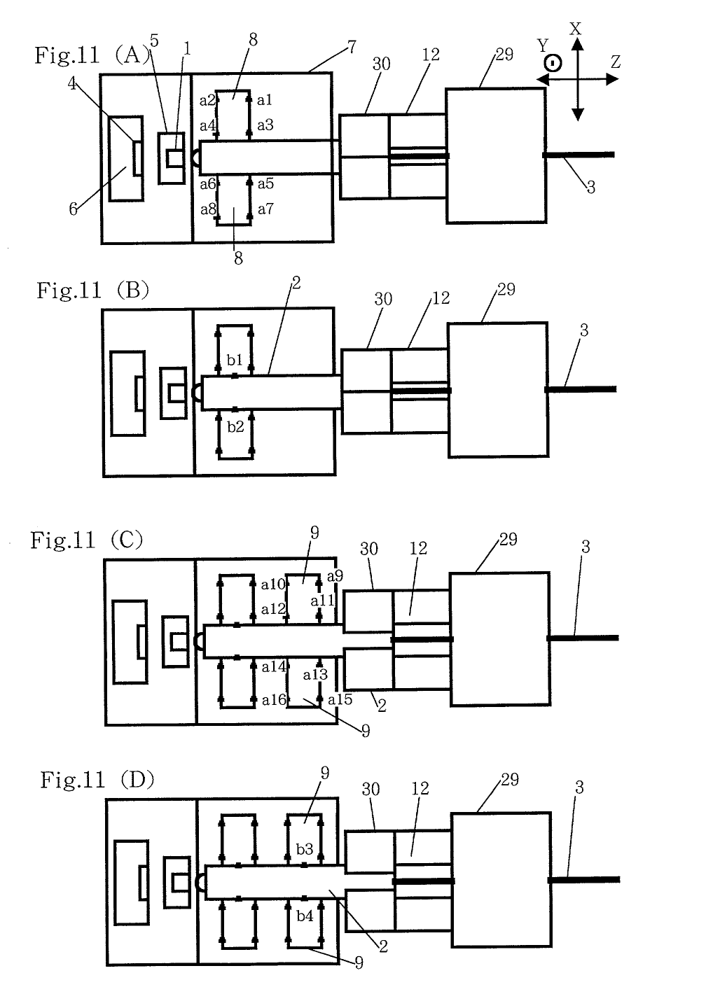

FIGS. 11(A) to (D) illustrate a process of performing the adjustment of optical axis in the optical ferrule-attached fiber 3 using a ferrule holder 29 according to the first embodiment of the present invention.

First of all, the LD carrier 5 on which the semiconductor laser element 1 has been mounted as well as the PD carrier 6 on which the photodiode 4 has been mounted are soldered to the base 7.

Subsequently, the side of the ferrule 2 is pinched by and between the pinching grooves 31 of the pinching member pair 30 in the ferrule holder 29 in the non-swingable manner (see FIG. 10(C)). The first supporting member 8 is then positioned along the ferrule 2 in place. If necessary, the gap between the ferrule 2 and the first supporting member 8 is secured. After the alignment of optical axis in the ferrule 2 is then performed in the X-, Y- and Z-axis directions, the first supporting member 8 is fixed to the base 7 through YAG laser welding (see FIG. 11(A) relating to welding spots a1-a8).

Subsequently, the alignment of optical axis in the ferrule 2 is again carried out in the X-, Y- and Z-axis directions under the same condition. Thereafter, the forward end of the ferrule 2 (which faces the semiconductor laser element 1) is fixed to the first supporting member 8 through YAG laser welding (see FIG. 11(B) relating to welding spots b1 and b2).

Subsequently, the pinching members 30 are opened to a predetermined spacing (e.g., 0.2 mm) by the opening/closing member 12 so that the ferrule 2 will be swingable while pinching the side of the ferrule 2 (see FIG. 10(D)).

Under such a condition, the second supporting member 9 is positioned along the ferrule 2 in place. The ferrule 2 is then moved about the welding spots b1 and b2 between the first supporting member 8 and the ferrule 2 in the leverage manner. The alignment of optical axis in the ferrule 2 is then carried out in the X- and Y-axis directions. Thereafter, the second supporting member 9 is fixed to the base 7 through YAG laser welding (see FIG. 11(C) relating to welding spots a9-a16).

Finally, the ferrule 2 is moved in the Y-axis direction or the X- and Y-axis directions. The ferrule 2 is moved about the YAG laser welding spots b1 and b2 between the first supporting member 8 and the ferrule 2 in the leverage manner. The alignment of optical axis between the semiconductor laser element 1 and the optical fiber 3 is then carried out. Thereafter, the side of the ferrule 2 is fixed to the second supporting member 9 through YAG laser welding (see FIG. 11(D) relating to welding spots b3 and b4).

According to the sixth embodiment of the present invention, the adjustment of optical axis in the optical ferrule-attached fiber 3 is carried out while pinching the side of the ferrule 2 after the ferrule 2 has been fixed to the first supporting member 8 and when the pinching member pair 30 is opened to the predetermined spacing. Therefore, the sufficient range of leverage movement can be secured. At the same time, the welding spots b1, b2 or a1-a8 can be prevented from being cracked, damaged or deformed due to an excess load on the YAG welding portions between the first supporting member 8 and the ferrule 2. As a result, the reliability of the product can be improved.

Since the pinching grooves 17 of the pinching members 30 used in the ferrule holder 29 are symmetrical to each other about the axis of the ferrule 2, the ferrule 2 can stably be moved within and between the pinching grooves 17. This can reduce time required to perform the alignment of optical axis.

### SEVENTH EMBODIMENT

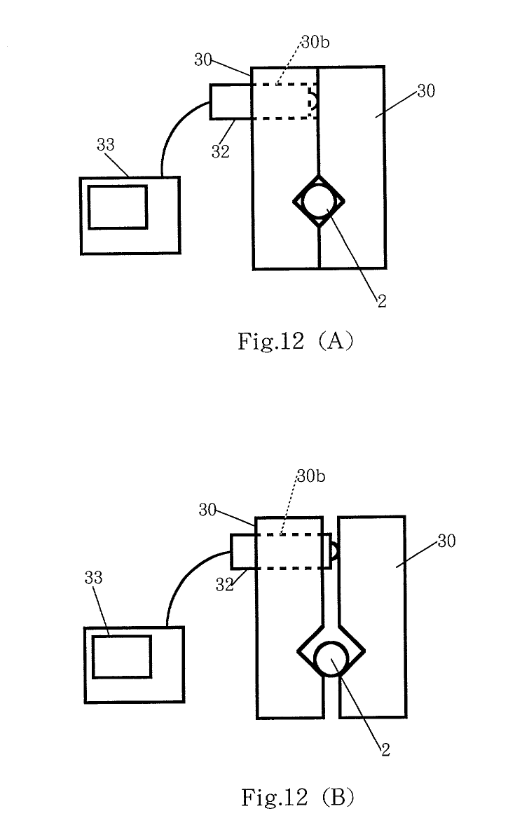

FIG. 12 is a front view of a ferrule holder according to the seventh embodiment of the present invention: FIG. 12(A) illustrates a pair of pinching members which are closed to pinch the ferrule at the side thereof in a non-swingable manner; and FIG. 12(B) illustrates the pair of pinching members which are opened into a predetermined spacing to pinch the ferrule at the side thereof in a swingable manner.

Referring to FIG. 12, one of a pair of pinching members 30 in the seventh embodiment (which is located leftward as viewed in FIG. 12) is provided with a measuring device 32 such as a digital micrometer for measuring the spacing between the pair of pinching members 30. The measuring device 32 is movably inserted into an opening 30b formed through said one pinching member 30. The measurement in the measuring device 32 is displayed on a monitor 38 connected to the measuring device 32.

According to the seventh embodiment, the measuring device 32 can always monitor the spacing between the pinching members 30. Even if there is dispersion in the diameter from one ferrule 2 to other, therefore, the pinching members 30 can always be opened to a constant spacing based on the measurement in the measuring device 32. Such a measuring device 32 may be located in the respective one of the pinching members 30.

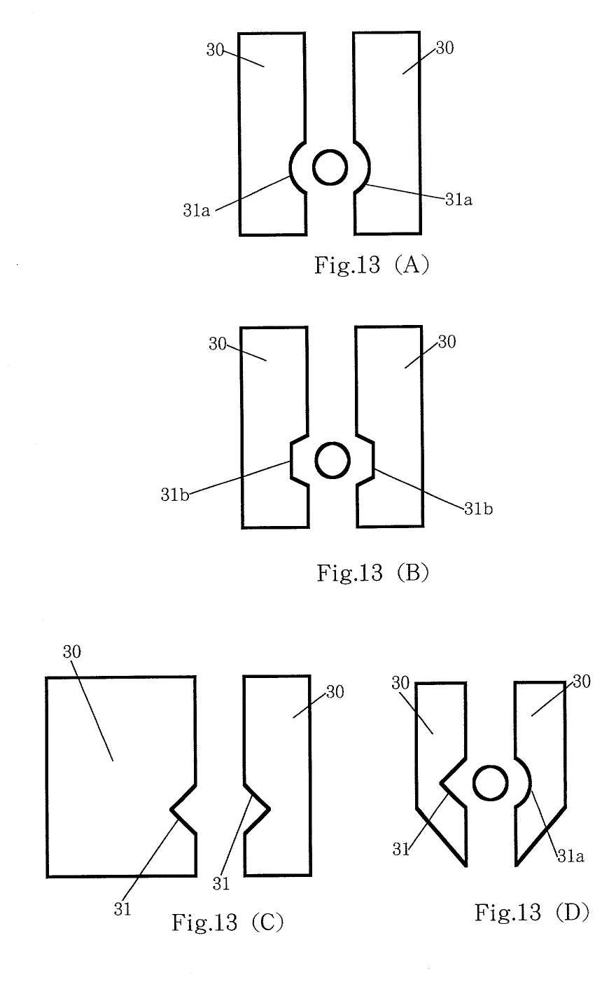

FIGS. 13(A) to (D) illustrate various modifications of the pinching members 30. It is preferred that the pinching members 30 have pinching grooves 31 symmetrical to each other about the axis of the ferrule 2. For example, each of the pinching grooves may be of semi-circular cross-section as shown by 31a in FIG. 13(A) and of trapezoidal cross-section as shown by 31b in FIG. 13(B). Alternatively, it is not necessarily required that the pair of pinching members 30 is of the same configuration. For example, one of the pinching members 30 (which is located leftward as viewed in FIG. 13(C)) may have a width larger than that of the other pinching member 30.

Furthermore, the pinching grooves 31 and 31a in the pinching members 30 may be asymmetrical to each other about the axis of the ferrule 2, as shown in FIG. 13(D).

### EIGHTH EMBODIMENT

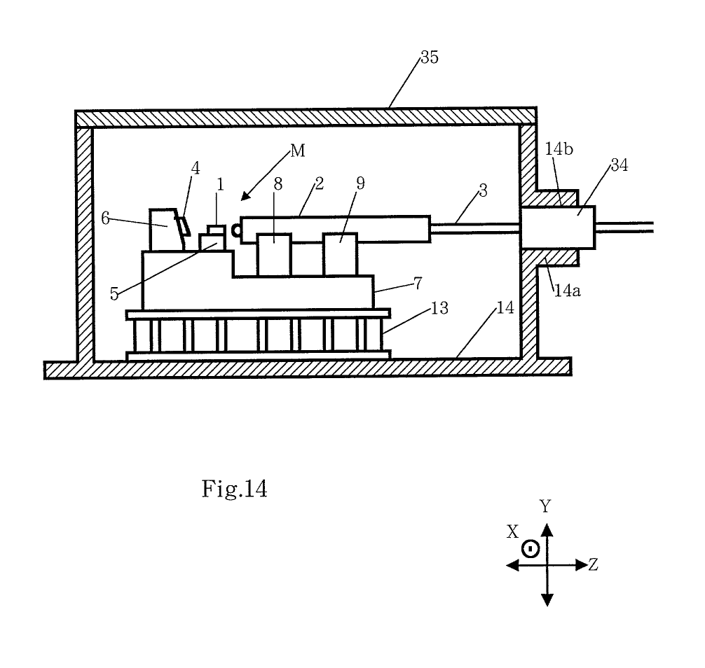

FIG. 14 illustrates a process of making a semiconductor laser module according to the eighth embodiment of the present invention.

First of all, the LD carrier 5 on which the semiconductor laser element 1 has been mounted as well as the PD carrier 6 on which the photodiode 4 has been mounted are soldered to the base 7.

Subsequently, the cooling device 13 is soldered in the package 14.

Subsequently, the base 7 is soldered on the cooling device 13.

Subsequently, the optical ferrule-attached fiber 3 is introduced into the package 14 through the aperture 14b formed in the package 14 through the side 14a thereof.

Subsequently, the optical ferrule-attached fiber 3 is fixed to the base 7 through laser welding after the adjustment of optical axis has been carried out in the optical ferrule-attached fiber 3 through any of the processes described in connection with the aforementioned embodiments.

Subsequently, the optical ferrule-attached fiber 3 is soldered to the side 14a of the package 14 within the aperture 14b through a connecting member 34.

Subsequently, a closure 35 is placed over the top of the package 14, with the peripheral edge thereof being then soldered or laser welded to the package 14. Thus, the package 14 is air-tightly sealed by the connecting member 34 and closure 35.

The present invention may be applied to any case wherein the optical ferrule-attached fiber is optically coupled with another optical part such as a light emitting element, light-receiving element or other optical ferrule-attached fiber, in addition to the semiconductor laser element.

According to the embodiments of the present invention, the adjustment of optical axis is carried out while pinching the side of the ferrule 2 through the relatively short line contact or point contact in the longitudinal direction of the ferrule after the ferrule has been fixed to the first supporting member 8. Therefore, the sufficient range of leverage movement can be secured. At the same time, the welding spots b1, b2 or a1-a8 can be prevented from being cracked, damaged or deformed due to an excess load on the YAG welding portions between the first supporting member 8 and the ferrule 2. As a result, the reliability of the product can be improved.

Where the adjustment of optical axis in the optical ferrule-attached fiber is carried out while pinching the side of the ferrule after the ferrule has been fixed to the first supporting member and when the pinching members are opened to a predetermined spacing, the sufficient range of leverage movement can be secured. At the same time, the welding spots b1, b2 or a1-a8 can be prevented from being cracked, damaged or deformed due to an excess load on the YAG welding portions between the first supporting member 8 and the ferrule 2. As a result, the reliability of the product can be improved.

Where two pinching grooves formed in the pinching member pair used in the ferrule holder are symmetrical to each other about the axis of the ferrule, the ferrule may stably be moved within the pinching grooves. This can reduce time required to perform the alignment of optical axis.

The present invention is not limited to the aforementioned embodiments, but may be carried out in any of various other forms without departing from the spirit and scope of the invention as claimed in the appending claims.

For example, in the semiconductor laser module M according to the first embodiment as shown in FIG. 1, the semiconductor laser module may be mounted on the base 7 directly, rather than through the cooling device 13. Alternatively, the semiconductor laser element 1 may be mounted on the base directly, rather than through the LD carrier 5. The ferrule 2 may be fixed only by the supporting member 8. In addition, the ferrule may be fixed by any other suitable means such as resin or adhesive, rather than the YAG laser welding.

1. A ferrule holder for holding a ferrule in an optical ferrule-attached fiber when the adjustment of optical axis in said optical ferrule-attached fiber to be optically coupled with an optical part is to be performed, said ferrule holder being characterized by a pair of pinching members for pinching the side of said ferrule through a line contact relatively short in the longitudinal direction of the ferrule or a point contact.

2. The ferrule holder according to claim 1, characterized by a further pair of pinching members for pinching said ferrule through a line contact relatively long in the longitudinal direction of the ferrule.

3. The ferrule holder according to claim 2, characterized by that said two pairs of pinching members are formed integrally in one member.

4. The ferrule holder according to claim 1, characterized by that the side of the ferrule is pinched at at least two locations through the line contact relatively short in the longitudinal direction of the ferrule or the point contact.

5. The ferrule holder according to claim 1, characterized by that said relatively short line contact is equal to or longer than 0.001 mm and less than 1 mm.

6. A ferrule holder comprising a pair of pinching members for pinching a ferrule in a optical ferrule-attached fiber to be optically coupled with an optical part when the adjustment of optical axis in the optical ferrule-attached fiber is to be performed, said ferrule holder being characterized by that each of said pair of pinching members includes a pinching groove formed therein and extending along the axis of said ferrule.

7. The ferrule holder according to claim 6, characterized by that said pinching grooves are formed to provide a symmetric configuration about the axis of said ferrule.

8. The ferrule holder according to claim 1, characterized by that at least one of said pinching members includes measuring means for measuring the spacing between said pair of pinching members.

9. A method of making a semiconductor laser module, said semiconductor laser module comprising a semiconductor laser element and an optical ferrule-attached fiber for receiving a laser beam emitted from the semiconductor laser element, said method being characterized by a step of performing the adjustment of optical axis in said optical ferrule-attached fiber while pinching the side of said ferrule through a line contact relatively short in the longitudinal direction of the ferrule or a point contact.

10. A method of making a semiconductor laser module, said semiconductor laser module comprising a semiconductor laser element and an optical ferrule-attached fiber for receiving a laser beam emitted from the semiconductor laser element, said method being characterized by a first step of performing the adjustment of optical axis in the optical ferrule-attached fiber while pinching the side of said ferrule at at least two locations through a line contact relatively long or short in the longitudinal direction of the ferrule or a point contact, and a second step of performing the adjustment of optical axis in said optical ferrule-attached fiber while pinching the side of said ferrule through a line contact relatively short in the longitudinal direction of the ferrule or a point contact.

11. A method of making a semiconductor laser module, said semiconductor laser module comprising a semiconductor laser element and an optical ferrule-attached fiber for receiving a laser beam emitted from the semiconductor laser element, said method being characterized by a step of performing the adjustment of optical axis in said optical ferrule-attached fiber while pinching the side of said ferrule by and between pinching grooves formed by a pair of pinching members in a ferrule holder.

12. The method of making a semiconductor laser module according to claim 11, characterized by a step of performing the adjustment of optical axis in said optical ferrule-attached fiber while pinching the side of said ferrule in a swingable manner when said pair of pinching members are moved away from each other with a predetermined spacing.

13. The method of making a semiconductor laser module according to claim 11, characterized by that the adjustment of optical axis in said optical ferrule-attached fiber is performed while pinching the side of said ferrule by and between the pinching grooves of the pair of pinching members in the ferrule holder in a non-swingable manner.

14. The ferrule holder according to claim 9 for holding a semiconductor laser module, said ferrule holder being characterized by that it is adapted to hold a ferrule in a optical ferrule-attached fiber when the adjustment of optical axis in the optical ferrule-attached fiber is to be performed before the optical ferrule-attached fiber is optically coupled with an optical part, said ferrule holder having a pair of pinching members for pinching the side of said ferrule through a line contact relatively short in the longitudinal direction of the ferrule or a point contact.

15. A method of making a semiconductor laser module, characterized by the steps of:
fixedly mounting a semiconductor laser element on a base;
fixedly mounting a cooling device in a package;
fixedly mounting said base on said cooling device;
introducing an optical ferrule-attached fiber into the package through an opening formed in said package through the side thereof;
performing the adjustment of optical axis in said optical ferrule-attached fiber using a ferrule holder which has a pair of pinching members for pinching the side of said ferrule through a line contact relatively short in the longitudinal direction of the ferrule or a point contact, said optical ferrule-attached fiber being fixed to said base after the adjustment of optical axis;
fixedly mounting said optical ferrule-attached fiber on the side of the package within said opening in said package; and
air-tightly sealing said package.
